(19) United States
(12) Patent Application Publication
(10) Pub. No.: US 2009/0313579 A1
(43) Pub. Date: Dec. 17, 2009

(54) SYSTEMS AND METHODS INVOLVING FAVICONS

(75) Inventor: Joshua R. Poulson, Ridgefield, WA (US)

Correspondence Address: CANTOR COLBURN LLP - IBM TUSCON DIVISION, 20 Church Street, 22nd Floor, Hartford, CT, 06103, US

(73) Assignee: International Business Machines Corporation, Armonk, NY (US)

(21) Appl. No.: 12/138,543

(22) Filed: Jun. 13, 2008

(51) Int. Cl. G06F 3/048

(52) U.S. Cl. 715/809

(57) ABSTRACT

A method for displaying metadata associated with webpage content, the method comprising, receiving a designation of webpage content displayed on a first webpage, copying the designated webpage content from the first webpage, determining whether document object model data associated with the first webpage includes a favicon, extracting favicon data from document object model data associated with the first webpage responsive to determining that the document object model data associated with the first webpage includes a favicon, generating a visual representation of the favicon data responsive to extracting the favicon data, generating a content box on a second webpage, displaying the content box on the second webpage, displaying the webpage content in the content box on the second webpage, and displaying the visual representation of the favicon data in the content box responsive to generating the visual representation.

### BACKGROUND OF THE INVENTION

1. Field of the Invention

This invention relates generally to a method and system for displaying metadata, and particularly to displaying metadata on an Internet web page.

2. Description of Background

Metadata is data that describes other data. For example on an Internet webpage, a photograph may have associated metadata that includes the name of the photographer who took the picture.

Internet web pages may include information from a variety of sources including other web pages. For example, a web page may include quotations, webpage links, photos, graphics, or multi-media content that has come from other webpages. A method for indicating sources of information on a webpage is desired.

### SUMMARY OF THE INVENTION

The shortcomings of the prior art are overcome and additional advantages are achieved through an exemplary method for displaying metadata associated with webpage content, the method comprising, receiving a designation of webpage content displayed on a first webpage, copying the designated webpage content from the first webpage, determining whether document object model data associated with the first webpage includes a favicon, extracting favicon data from document object model data associated with the first webpage responsive to determining that the document object model data associated with the first webpage includes a favicon, generating a visual representation of the favicon data responsive to extracting the favicon data, generating a content box on a second webpage, displaying the content box on the second webpage, displaying the webpage content in the content box on the second webpage, and displaying the visual representation of the favicon data in the content box responsive to generating the visual representation.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIGS. 1 and 2 illustrate prior art examples of webpages.

FIG. 3 illustrates an exemplary embodiment of a webpage.

FIG. 4 illustrates an exemplary system for displaying web content and metadata.

FIG. 5 is a block diagram of an exemplary method for processing and displaying metadata.

The detailed description explains the preferred embodiments of the invention, together with advantages and features, by way of example with reference to the drawings.

### DETAILED DESCRIPTION OF THE INVENTION

Systems and methods involving displaying metadata are provided. Several exemplary methods and systems are described.

An Internet webpage may include webpage content taken from other webpages, such as, for example, text, graphics, audio files, video files, multi-media files, photographs, and webpage addresses. The webpage content may include associated metadata that describes the information. For example, a text quote from a webpage may include metadata that identifies the webpage and the author of the text.

Previous methods for displaying metadata may be cumbersome and distracting to a user, for example, displaying a webpage address with a text quote may result in an unappealing and confusing presentation to a user. “Popups” that display metadata when a user passes a cursor over a text quote may also be distracting. Complicated textual representations of metadata may also be difficult to quickly comprehend. The systems and methods described below offer an intuitive presentation of metadata associated with webpage content.

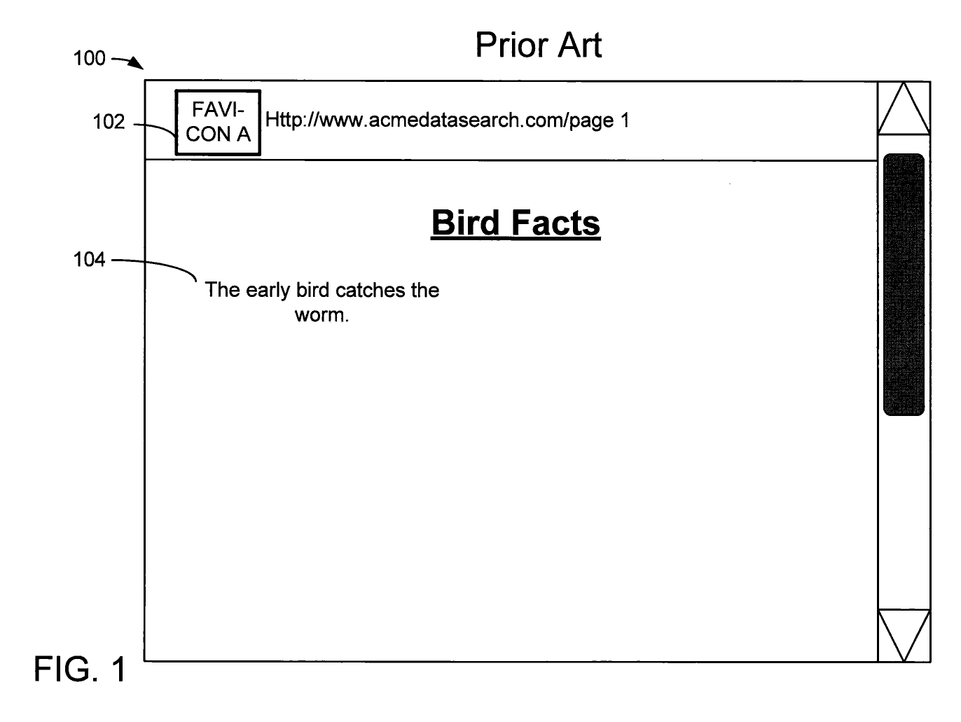

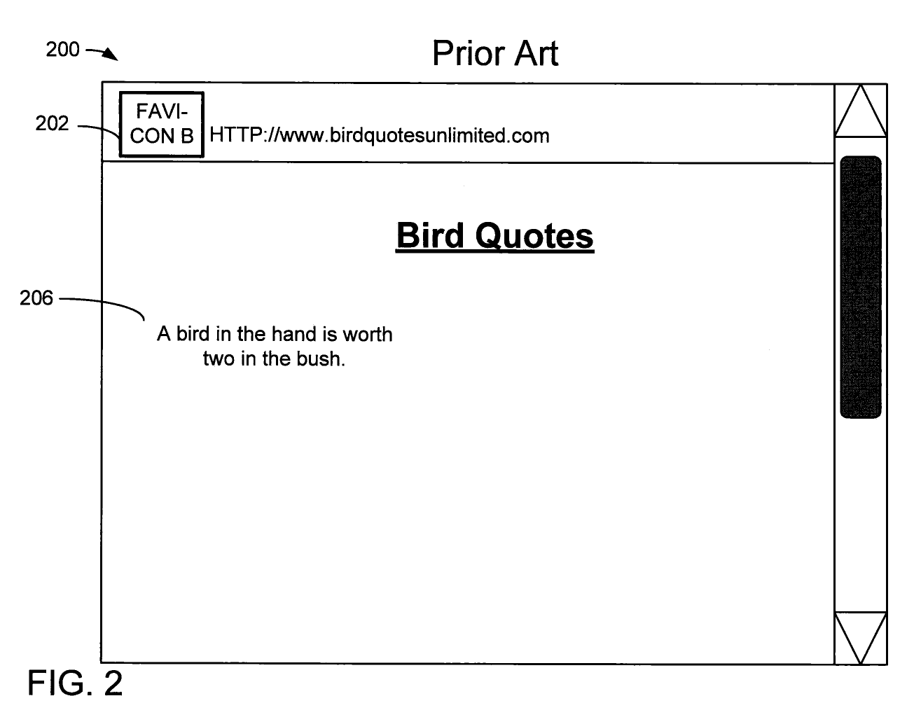

FIGS. 1 and 2 illustrate prior art examples of webpages 100 and 200. Referring to FIG. 1, the webpage 100 includes a first favicon 102 that is associated with the webpage 100. Favicons may be saved in document object model data that is associated with the website 100. Favicons are used as visual indicators or logos to visually represent a website or webpage. For example, a corporate website may have a favicon that is the logo of the corporation. The favicon is displayed in bookmark tabs of website browsers, and in fields having the HTML address of the website. Favicons allow for easy recognition of websites.

The Document Object Model (DOM) specifies that a header link with a relation of “shortcut icon” can specify the URI of a icon for that webpage, an older standard of having a file named “favicon.ico” may also be used. Web browser software uses the URI or default location to request and receive the favicon from a website. A weblog, for example, would use a wget shell comand to extract the file for use in a posting after determining the URL

The webpage 100 also includes web content 104, in the illustrated example, the web content is a text quote. Other examples of web content include, website links, graphics, photographs, videos, multi-media content, audio files, and other documents. FIG. 2 illustrates the webpage 200, and includes a second favicon 202, and web content 206.

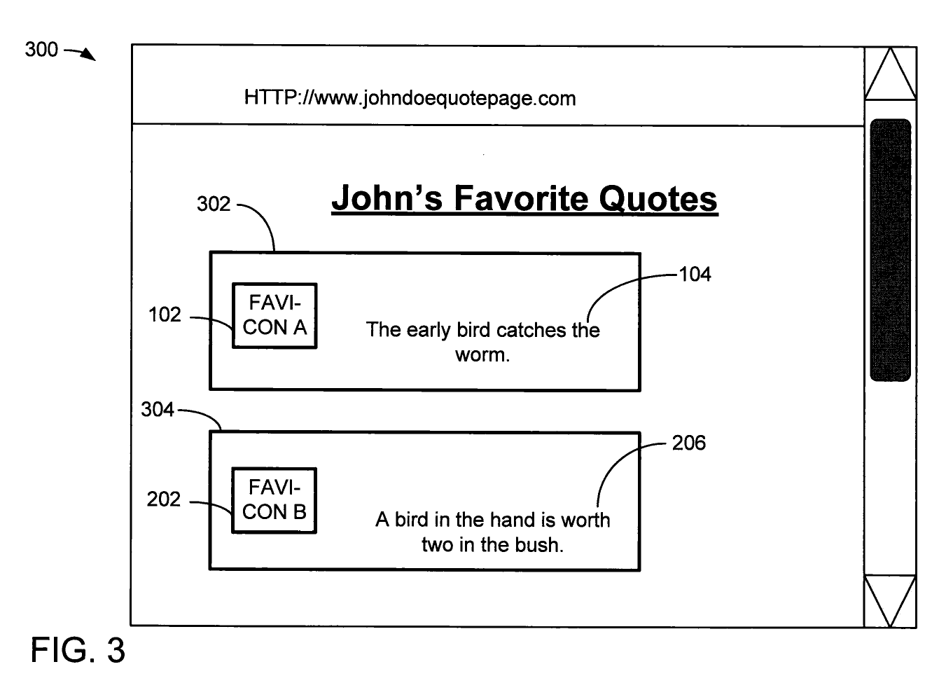

FIG. 3 illustrates an exemplary embodiment of a webpage 300. The webpage 300 is an exemplary result of a method for displaying metadata associated with web content. A website author has copied the web content 104 and the web content 206 from the webpages 100 and 200 onto the webpage 300. The website 300 includes a display window having a first content box 302 and a second content box 304. The web content 104 is displayed in the first content box with the first favicon 102. Thus, a user may easily recognize the source webpage that the web content was copied from. The web content 206 is displayed in the second content box 304 with the second favicon 304. The placement of the favicons in the content boxes allows fast and intuitive recognition of the source of the web content.

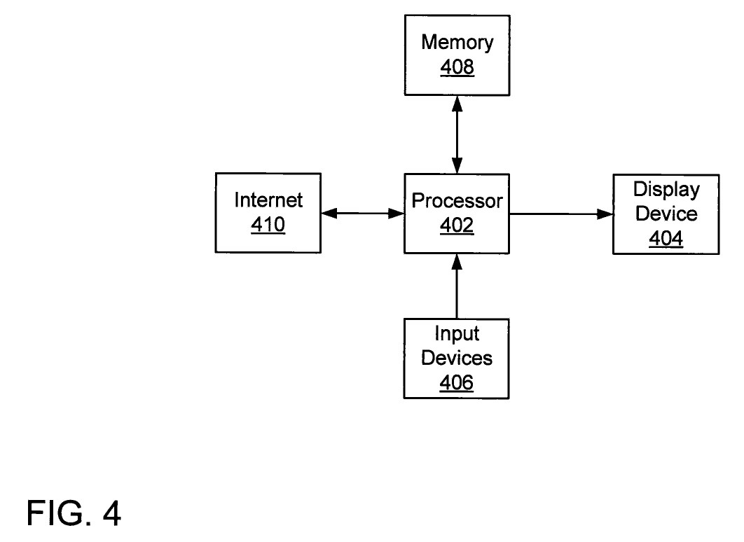

FIG. 4 illustrates an exemplary system for displaying web content and metadata. The system includes a processor 402 communicatively connected to a display device 404, input devices 406, memory 408 and the Internet 410.

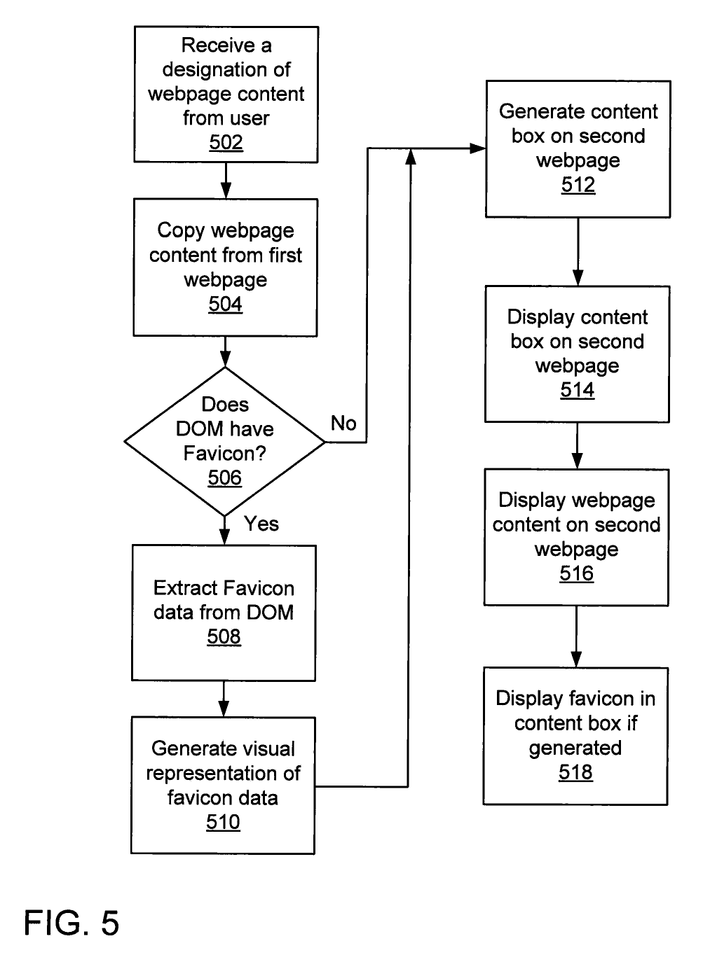

FIG. 5 is a block diagram of an exemplary method that may be performed by the system of FIG. 4. Referring to FIG. 5, the method begins by receiving a designation of webpage content from a user in block 502. The designation may include, for example, a user selecting web page content on a web page. In block 504, the designated webpage content is copied into memory. In block 506 it is determined whether the DOM associated with the webpage includes a favicon. If a favicon is present, the favicon data is extracted from the DOM in block 508. If a favicon is not present, the method moves to block 512. In block 510, a visual representation of favicon data is generated. In block 512, a content box is generated on a second webpage. The content box is displayed on the second webpage in block 514. In block 516, the webpage content is displayed on the second webpage. In block 518 the favicon is displayed in the content box.

While the preferred embodiment to the invention has been described, it will be understood that those skilled in the art, both now and in the future, may make various improvements and enhancements which fall within the scope of the claims that follow. These claims should be construed to maintain the proper protection for the invention first described.

1. A method for displaying metadata associated with webpage content, the method comprising:
receiving a designation of webpage content displayed on a first webpage;
copying the designated webpage content from the first webpage;
determining whether document object model data associated with the first webpage includes a favicon;
extracting favicon data from document object model data associated with the first webpage responsive to determining that the document object model data associated with the first webpage includes a favicon;
generating a visual representation of the favicon data responsive to extracting the favicon data;
generating a content box on a second webpage;
displaying the content box on the second webpage;
displaying the webpage content in the content box on the second webpage; and
displaying the visual representation of the favicon data in the content box responsive to generating the visual representation.
